(19) United States
(12) Patent Application Publication
(10) Pub. No.: US 2019/0318376 A1
(43) Pub. Date: Oct. 17, 2019

(54) System for Incentive Eligibility and Validation for Transport Demand Management (TDM) programs

(71) Applicants: Michael Papineau, East Toronto (CA); Mark Feltham, East Toronto (CA)

(72) Inventors: Michael Papineau, East Toronto (CA); Mark Feltham, East Toronto (CA)

(21) Appl. No.: 15/950,559

(22) Filed: Apr. 11, 2018

(51) Int. Cl. G06Q 30/02

(52) U.S. Cl. CPC G06Q 30/0226; H04W 4/021

(57) ABSTRACT

The present invention is a method and system to confirm commuter eligibility for municipal transportation incentives. In an embodiment the present invention uses a Reward Threshold in combination with an API-bearing mobile device to create and send positional, temporal, and identifying information to a central Server. The Server maintains a record of information received and uses said information to apportion and track progress toward municipal transportation incentives. Upon a user's accumulation of a pre-authorized number, type, or kind of awards, the Server determines a user's having qualified for one or more rewards and/or incentives and enables redemption thereof.

### CLAIM TO PRIORITY

This Non-Provisional application claims under 35 U.S.C. § 120, the benefit as a Continuation-In-Part of the non-Provisional application Ser. No. 15/789,503, filed Oct. 20, 2017, Titled “Vehicle Occupancy Verification Utilizing Proximity Confirmation” which is hereby incorporated by reference in its entirety.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Many municipalities have determined that encouraging residents to employ ride-sharing or similar “green” transportation options create health and environmental benefits that inure to the benefit of the residents themselves. For instance, where car-pooling reduces the number of vehicles on the road during a given commuter period, it can be deduced that fewer harmful automotive emissions are introduced into the environment. Reduction of such harmful or toxic emissions can lead to an overall improvement of environmental as well as individual health. In addition, a decrease in overall active vehicle numbers can lead to longer-lived roads and can minimize the expense inherent in road-rebuilding.

Health, environmental, and fiscal benefits to ride-sharing programs notwithstanding, some municipalities have employed incentive programs to encourage “green” transportation adoption. Such incentive programs reward residents for participating in municipally-preferred transportation options such as, for example, ride-sharing, biking, or even walking.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a process flow diagram for an exemplary system operation consistent with certain embodiments of the present invention.

FIG. 2 is a connection diagram for an associated device co-location determination consistent with certain embodiments of the present invention.

FIG. 3 is a process flow diagram for an exemplary system operation consistent with certain embodiments of the present invention.

FIG. 4 is a process flow diagram for an exemplary associated device co-location determination operation consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

References herein to “device” indicate electronic devices that include a radio frequency (RF) transmitter and contemplate but are not limited to include a mobile phone, a laptop, an electronic tablet, or any personal digital assistance device.

References to “GPS” indicate reference to the Global Positioning System space-based radio-navigation satellite array and associated technologies.

References herein to “sensor” include presence-detection devices based on optic detection principles, magnetic detection principles, or a combination of optic and magnetic detection principles.

References herein to “beacon” refer to a wired or wireless low powered, near-radius signal broadcasting device such as, by way of non-limiting example, devices that use the i-beacon or eddystone protocols, or Bluetooth or Bluetooth Low Energy (BLE) emulation from a mobile device, any other device to broadcast Bluetooth signals.

References herein to “transportation modality” or “transportation modalities” refer to a method of transportation such as walking, riding a bike or other manually operated wheeled conveyance, riding within a tram, bus, shuttle bus, train, car, van, or other wheeled vehicle having a motor, where the modality of transportation may be either a private conveyance, or a conveyance operated by a public transportation system.

References herein to “Reward” or “Rewards” refer to items including but not limited to points, money, passes, products or services or social badges.

References herein to “Reward Threshold” refer to signaling mechanisms employing technologies including but not limited to geo-fencing, GPS validation, sensor validation, stand-alone beacons, custom signals such as beacon to phone signaling, and mobile device Bluetooth beacons, whether such technologies are employed singularly or in combination.

Municipalities that choose to adopt “green” transportation incentive programs seek to direct commuter behavior by the doling out of certain tangible or intangible rewards. As in any reward-based incentive program, the reward offeror must be on guard for fraudulent claims for such rewards. Simultaneously, a conscientious reward offeror will wish to ensure that rewards are properly given to deserving commuters who demonstrate earnest and lawful program compliance. Consequently, a need exists for a system and method for verifying that a commuter has in fact participated in “green” transportation options, and as such qualifies for municipal incentives.

In an embodiment, the invention described herein is a mobile-device application that may use geofencing, GPS location services, user interaction, a primary Bluetooth source signal, sensors external to the mobile device, and one or more central servers, such server or servers designed to ascertain program compliance based upon positional and other data received from the source signal and external sensors. In a non-limiting example, the innovation may utilize any of the identified sensor and signal capabilities in any combination to determine and verify a user and their interaction with any transportation modality.

In a non-limiting, carpool-related example, a primary Bluetooth source signal may be used as a proxy for a self-identified “carpooling vehicle.” A vehicle so identified would be expected to carry at least one associated device that may be considered a proxy for a carpooler. A Bluetooth device or primary driver's mobile phone inside the vehicle would, sua sponte, broadcast a Bluetooth low-powered transmission signal detectable by Bluetooth receivers, such as, in a non-limiting example, one or more mobile phones in the immediate proximity, where the immediate proximity may be in the range of 0 to about 15 feet. The receiving devices communicate with the system server(s) to confirm their proximity to the designated Bluetooth transmitting device, and this mechanism is used to confirm the close proximity, as stated above, of the devices at each reward location. General proximity to the reward location(s) such as toll-free highway access points, are determined by the GPS location of the driver's mobile phone. When the driver enters a reward zone, the associated pooled devices are again interrogated by the system server(s) to confirm close proximity within the vehicle via the confirmation of the Bluetooth signal still being detected.

In a non-limiting example, the system and method so described may be employed to validate program participation for all approved transportation modes. Using technologies including geo-fencing, GPS validation, sensor validation, stand-alone beacons, custom signals such as beacon to phone signaling, mobile device Bluetooth beacons or any combination of the recited technologies, the present invention may be used to establish, determine and verify interaction and use of transportation modes and establish and assign rewards to all participants in said program. The generation and award of such rewards may be subject to verification of transportation mode and threshold use for modes of travel, such as walking, biking, car or van pooling, or transit use.

In an embodiment, the relative criteria for incentive-compliant commuting may be the commuter's travel along routes bearing installed beacon reward thresholds. A system embodying the invention may use an identifier key to help validate use. A system-specific Application Programming Interface (API) provides the most recent identifier key. Validation of incentive-compliant commuting may include validation for individuals walking past a set of beacons (such as at a crosswalk), validations for drivers in private vehicles, or validations for riders on a bus, train or other public transportation. Validation may take the form of the activation of an application on a mobile device, transmission of a validation signal from any mobile device, visual verification evidence transmitted from a user to the system server, collection of signals from a sensor installed within a vehicle or associated with the operator of a vehicle, or verification through the analysis of signals and data collected from a plurality of sensors or other devices such as, in a non-limiting example, emplaced beacon devices.

In a non-limiting example, beacons associated with the system through data communication with the system server may be installed in public transit vehicles, such as buses, trams, train cars, and other public transportation vehicles. The beacons will provide unique anchor point signals for the user phone to which they will confirm proximity. The beacons, which may, in a non-limiting example, be configured for use as confirmation signal emission sites, can be at fixed locations such as intersections or landmarks. Such beacons may also be mounted on mobile vehicles such as trains and buses to confirm the user's ridership of these vehicles by way of continuous proximity to the moving signal. In an additional and related non-limiting example, cars and vanpools may provide for Bluetooth verification between riders and a mounted beacon. In this non-limiting example, the driver's mobile device, such as a phone, iPad, or tablet, may emulate a beacon and broadcast a unique signal to all other mobile devices that are within the vehicle.

The system may use the validation of ridership for assigning reward levels for each transportation modality that may be totaled and tracked by the system. The system may prescribe certain participation reward levels for validated transportation, once again based upon the modality of the transportation in use, store data associated with the participation in transportation, again regardless of modality, in a commuter's database file, and allow the commuter to redeem rewards offered by the system. The overall validation model may provide rewards for particular participation thresholds and milestones as well as in exchange for participation levels and/or special awards relayed from one or more partner or third-party participant.

In an embodiment, if a user wishes to locate a public transportation option, the system may attempt to locate and present to the user one or more suitable transit options. Such suitable transit options may be presented to the user for action. Transit options located in this fashion may be paid for, in whole or in part, through the use of stored transportation rewards that have been accumulated by the user.

In an embodiment, static beacons mounted on municipal bus stops may be used primarily to determine when a participating commuter is boarding or getting off a bus. These same beacons can be used for pedestrian milestones and as start locations for bus riders who walk the last commuting distance to their destinations in interaction with an application installed within and operational on a mobile device associated with a transportation user. Transportation user milestones can also be provided through a crosswalk beacon network, which can in turn provide helpful information to the pedestrian commuter.

In a non-limiting example, beacons used for tracking pedestrian movements may be a part of the crosswalk beacon network. For instance, crosswalk beacons may trigger the System Server API to remind the user to use the crosswalk, to estimate the speed of the walker, or to estimate the time of arrival at a particular destination. The crosswalk beacon network may also serve to verify path and point presence as a user approaches each of the installed beacon sites.

The data collected by the sensors, interaction with beacons, and one or more applications on the mobile device may be analyzed by the system server to verify the use of each transportation modality. The data may provide information on route travelled, time or duration of the transportation activity, and proximity to various Bluetooth and BLE signals encountered during use of the transportation modality. The system may use the collected data to determine distance traveled, mode of transportation, eligibility for rewards, reward thresholds, and updating and management of rewards for each transportation user. In this non-limiting example, each transportation modality may have differing thresholds, reward levels, point levels, and verification requirements, however, once point amounts have been determined in accordance with these parameters, all validated rewards may be accumulated in an award database file associated with each transportation user.

In an embodiment, beacons installed in public transit vehicles such as buses and train cars can be used to confirm the ridership of users entering and leaving the vehicle, as previously described. The invention herein described can make use of this information to provide valuable insight to municipal transportation planners and other public officials as to occupancy and use of various public transportation options.

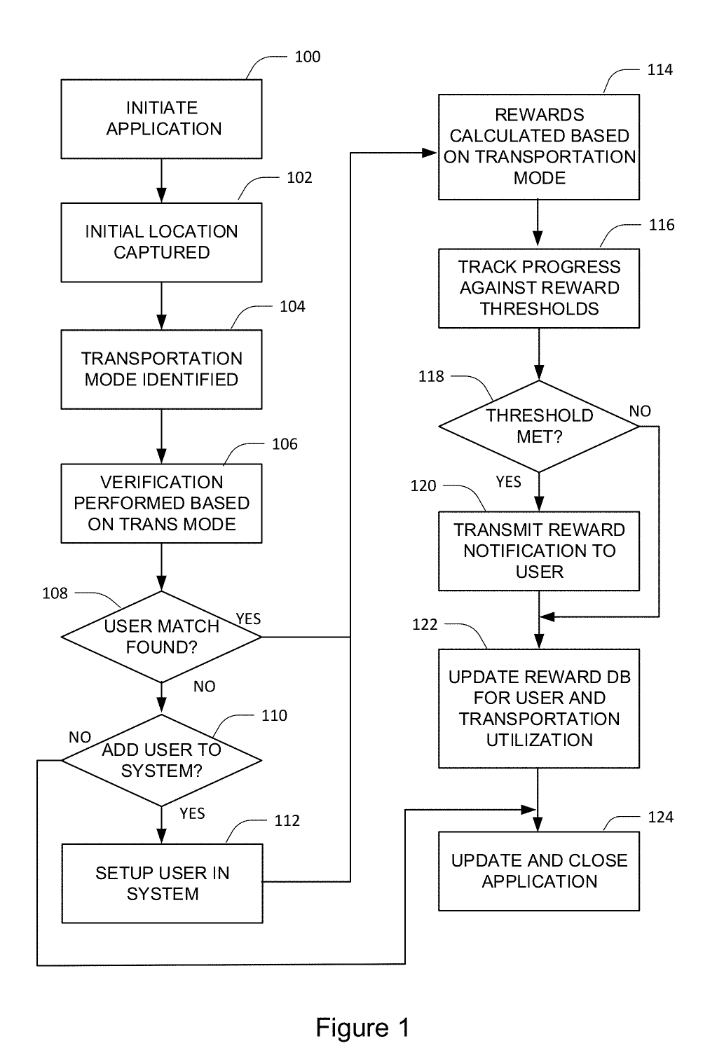

Turning now to FIG. 1, a process flow diagram for an exemplary system operation consistent with certain embodiments of the present invention is shown. At 100, one or more users may initiate the application on a mobile device to perform tracking, communication, and verification of transportation activities. At 102, when the application begins operation the application determines the initial geographic location of the mobile device. This initial determination of geographic location may be performed through the capture of GPS information from the mobile device, or the mobile device may transmit an initial location signal to a sensor or other sensing or mobile device through the use of Bluetooth, Bluetooth Low Energy (BLE), or other near field communication transmissions. Alternatively, a sensor or other communication device having a transceiver may capture identification information from each mobile device and utilize this identification information to assign the initial geographic location to each mobile device. The initial location information may then be transmitted to the system server either from the mobile device or from the communication device that has received an identifier transmission from said mobile device. The system server may then assign the initial geographic location as the starting point for a transportation activity utilizing one or more transportation modalities.

At 104, upon the capture of the initial location of the mobile device, the system server may then determine the mode of transportation associated with the mobile device for each initial starting point. Modes of transportation may include walking, riding a bike or other wheeled conveyance powered by human muscle, scooter or motorcycle, or traveling by tram, car, bus, train, or other public transportation method. At 106, the system server communicates with the mobile device to perform verification of the transportation mode in use by the user associated with the mobile device. At 108, the first step in the verification process is to attempt to match the user, through the information provided by the mobile device associated with the user, to determine that the user is currently enrolled within the system database. If the verification process determines that the user is enrolled in the system and is therefore eligible for rewards offered through the system, the system may continue to the determination of rewards for which an enrolled user may be entitled. Additionally, the system validates compliance with the use of the mode of transportation so as to verify eligibility for particular rewards available through the system or through a partner or third-party provider in coordination with the system.

If the system determines that there is no match for the user currently in the database, the user may be provided with the option to enroll in the system. If the user elects to be added to the system as an enrolled user, at 110, the system may update the system database with reference to the capture and addition of new user information, creating a new user record and adding the user to the system at 112.

At 114, the rewards database record maintained for the user, including newly enrolled users, associated with each mobile device may be updated to reflect the start of a transportation activity by the user and the determination of the transportation mode in use by the user. At this point in the process the system may be tracking the progress of a user on a public mode of transportation, may be checking for a subsequent or additional activation signal, or may be waiting for an active verification from a user in a vehicle.

At 116, the system may compare the progress of the user against pre-configured and established transportation reward thresholds to determine if the user has met the minimum threshold required to earn one or more rewards based upon meeting or exceeding one or more threshold values. Thresholds may be configured as milestones to be met, geographic distances to be traveled, the crossing of an established geofence or geographic border, the receipt of a secondary signal that indicates the completion of a pre-set transportation boundary condition, or special circumstances that are available through third party or external partner participation. In a non-limiting example, a threshold may be set as traveling a set distance on public transportation, regardless of the type of public transport utilized. In this non-limiting example, the threshold may also contain an additional reward validation established by a third party or partner if the end of the journey places the user at a location associated with said third party or partner. In another non-limiting example, the threshold may be set as the receipt of a signal from a second sensor that provides the system with the validation that the mobile device associated with a user has passed the location at which the second sensor is installed. At 118, the system compares user progress against reward thresholds and other reward criteria to determine if a reward threshold or other criteria has been met.

In an embodiment, at 120, if a threshold has been met, the system will formulate and transmit a reward notification to the mobile device associated with the user that has met the threshold or other reward criteria. At 122, the notification will also be stored within an electronic database maintained by the system server and the reward record database file for a particular user will be updated. Optionally, the notification may also be transmitted to a third party or partner to permit the partner organization to update and maintain their records with regard to rewards earned per user.

If the user at 110 does not wish to be added to the system, or reward processing for a user has completed, the system updates all records, closes the active application, and enters a state of waiting for the next transportation use at 124.

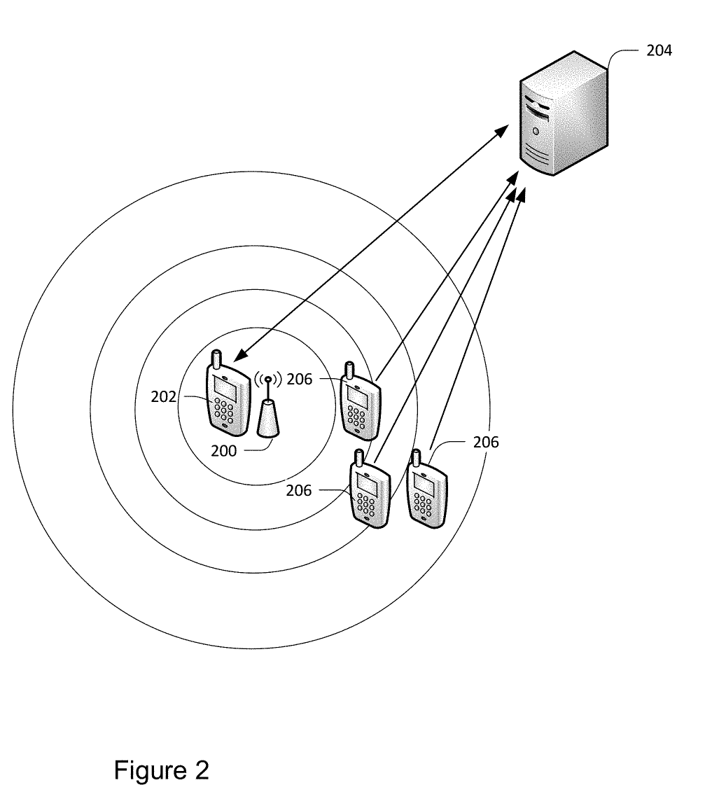

Turning now to FIG. 2, a connection diagram for an associated device co-location determination consistent with certain embodiments of the present invention is shown. When at least one of a collection of devices known to be ALL within proximity of a unique Bluetooth signal (either from a beacon or one of the devices themselves), comes within detectable proximity to a reward threshold, the primary device may communicate identifying information regarding associated devices 206 to server 204. Associated devices 206 may create one or more associations with a Bluetooth beacon enabled device 202. The Server 204 may then interrogate one or more Associated Devices 206 to confirm contemporaneous co-location of the Bluetooth signal that confirms proximity of one or more devices (202, 206) concurrent proximity to each other.

In a non-limiting example, confirming proximity of associated devices 206 to one another may use the primary Bluetooth source signal from the Bluetooth enabled device 202 or a beacon installed in the vehicle as the proxy for the vehicle 200, regardless of the vehicle type in use. The one or more associated devices 206 may be in the possession of multiple occupants of a vehicle, such as a car, bus, tram, train or other public conveyance configured for multiple occupancy. When the device emitting the primary Bluetooth source passes a reward threshold, the associated devices 206 may receive an interrogation signal from the Server 204 to confirm that the Associated devices 206 are still close to the Bluetooth source that is moving with the vehicle.

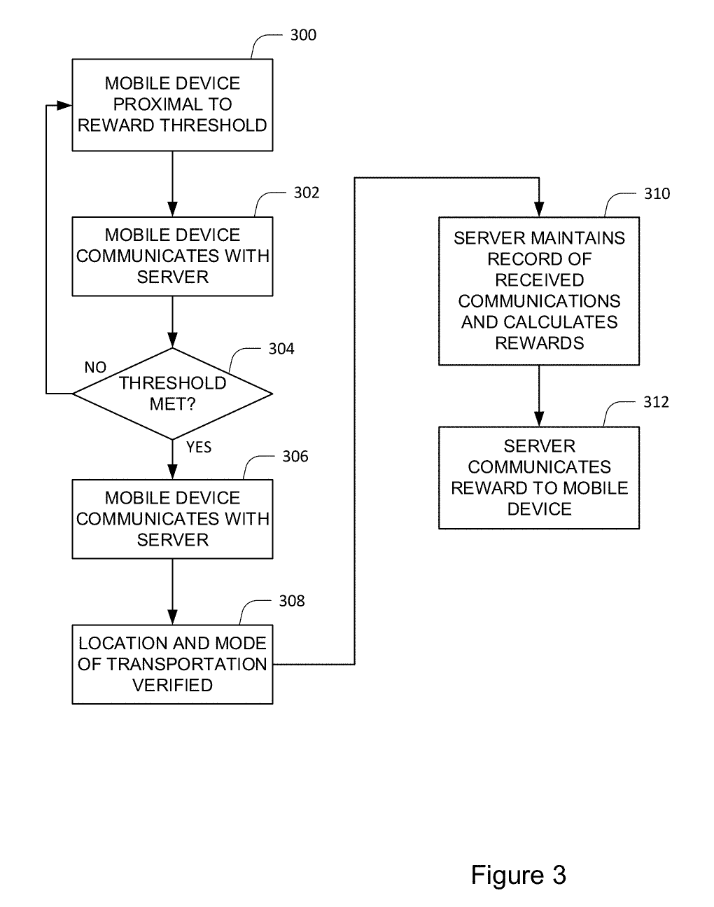

Turning now to FIG. 3, a process flow diagram for an exemplary system operation consistent with certain embodiments of the present invention is shown. At 300, an API-bearing mobile device may come within detectable proximity to a Reward Threshold. The Reward Threshold may consist of multiple sensing technologies including but not limited to geo-fencing, GPS validation, sensor validation, stand-alone beacons, custom transmissions such as beacon to phone signaling, and mobile device Bluetooth transmissions, and may permit both active and passive validation. At 302, the Reward Threshold communicates the presence of the mobile device and its own location to a central Server. At 304, the system server may analyze the data regarding the mobile device ID and location of the mobile device to determine if a reward threshold has been met. If a reward threshold has not been met, the system server may return to a state in which the system continues to collect data.

In an embodiment, if a reward threshold has been met, the server queries the mobile device for the most current location information. At 306, the mobile device may communicate with the server the location and mobile device ID information. Additionally, if the mobile device is physically located within a vehicle, such as a car, bus, train, tram, or other wheeled conveyance, the user may transmit validation information to the system server. Such validation information may take the form of text, photographic or video data that is communicated to the system server. The system server may validate compliance with the rules regarding the use of transportation, in its various forms, so as to verify eligibility for particular rewards available through the system or through a partner or third-party participant in programs managed and maintained by the system server. At 308, the system may verify and validate the location of the mobile device, and the user associated with the mobile device, and the mode of transportation in use. The system server may also communicate user messages to the mobile device, to be received by the user through the mobile device's user interface. Such user messages may, by way of non-limiting example, remind a pedestrian user to use a crosswalk, or may alert a shared transportation user of his or her estimated time of arrival. At 310, the system server maintains device-specific records of communications received from mobile devices and records reward thresholds assigned and/or awarded to individual mobile devices. The system server may calculate individual user's reward eligibility based upon a pre-determined algorithm. At 312, the Server communicates messages regarding rewards assigned and awarded to each mobile device, and, by extension, to the user associated with the mobile device.

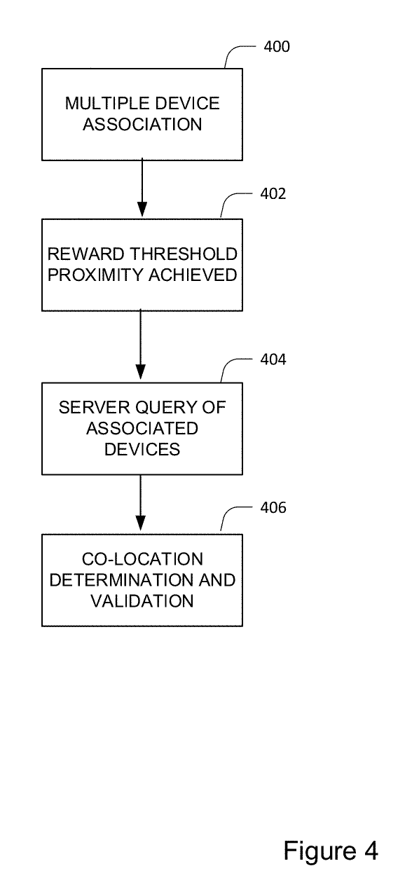

Turning now to FIG. 4, a process flow diagram for an exemplary associated device co-location determination operation consistent with certain embodiments of the present invention is shown. At 400, a mobile device and one or more Bluetooth beacon sensing devices are associated. In a non-limiting example, the mobile device may be reconfigured to emit a signal using the Bluetooth, Bluetooth Low Energy (BLE), or other radio frequency signal to permit the mobile device to emulate a beacon type device. At 402, at least one Bluetooth beacon sensing devices may approach within detectable proximity to a reward threshold as determined either by physical location, special offer based upon a location, or through participation in travel on one or more modes of transportation. At the same or a similar time, the one or more Bluetooth sensing devices may receive the beacon-like signal from the mobile device. At 404, Server interrogates the one or more associated devices to retrieve the beacon information retrieved from the mobile device by the one or more associated devices. At 406, the system server calculations confirm or deny contemporaneous co-location of Bluetooth beacon sensing devices and the mobile device to validate the use of a particular transportation mode. In a non-limiting example, the mobile device may emit a beacon-like signal that is captured by an associated Bluetooth sensing device at the beginning of a transportation segment, such as at the beginning of a bike trail, the entry into a crosswalk for walkers, or on a mode of public transportation where the driver or the vehicle contains a mobile device emitting a beacon-like signal. At the end of the transportation segment, such as at the terminus of a bike trail, the end point of the crosswalk, or when the beacon sensing device passes a mobile device previously recorded, the mobile device is once again validated as having collected the beacon signal. Upon the collection of the subsequent signal, the system server may determine that a user of the mobile device has completed an action such as passing through a crosswalk, or other delimited area, completed a bike trail, or exited a public transportation vehicle such as a bus, train, tram, or other vehicle. The user associated with the mobile device may then become eligible for any and all rewards assigned to the completion of such transportation segments.

While certain illustrative embodiments have been described, it is evident that many alternatives, modifications, permutations and variations will become apparent to those skilled in the art in light of the foregoing description.

We claim:

1. A method for confirming and incentivizing commuter behavior, comprising:
communicating to a server proximity confirmation of one or more mobile devices to one or more reward thresholds;
communicating to the server unique location information of the one or more reward thresholds;
maintaining a record of reward threshold communication;
calculating reward eligibility based upon a supplied algorithm; and
communicating calculated reward via a user interface.

2. The method of claim 1 where the mobile devices include any device equipped with a radio frequency (RF) transmitter module.

3. The method of claim 1 where the proximity confirmation is determined wholly or in part by application of geo-fencing, GPS validation, sensor validation, stand-alone beacons, custom signals such as beacon to phone signaling, and mobile device Bluetooth beacons, whether applied singly or in combination.

4. The method of claim 1 where communications to mobile devices are received through a mobile application.

5. The method of claim 1 where a user may accumulate multiple rewards.

6. The method of claim 1 where reward eligibility may be accurately calculated regardless of a user's mode of transportation.

7. A system of verifying and incentivizing commuter behavior, comprising:
a user interface;
one or more mobile devices;
one or more reward thresholds;
a server having a processor in wireless communication with one or more mobile devices and one or more reward thresholds;
the one or more reward thresholds communicating proximity confirmation of the one or more mobile devices to the server;
the one or more reward thresholds communicating unique location information to the server;
maintaining a record of reward threshold communication;
calculating reward eligibility based upon a supplied algorithm; and
communicating calculated reward via the user interface.

8. The system of claim 7 where the mobile devices include any device equipped with a radio frequency (RF) transmitter module.

9. The system of claim 7 where the proximity confirmation is determined wholly or in part by application of geo-fencing, GPS validation, sensor validation, stand-alone beacons, custom signals such as beacon to phone signaling, and mobile device Bluetooth beacons, whether applied singly or in combination.

10. The system of claim 7 where the user interface is a mobile application.

11. The method of claim 7 where a user may accumulate multiple rewards.

12. The method of claim 7 where reward eligibility may be accurately calculated regardless of a user's mode of transportation.
